(19) United States
(12) Patent Application Publication
(10) Pub. No.: US 2026/0070314 A1
(43) Pub. Date: Mar. 12, 2026

(54) Flexible Sheet with Graphic

(71) Applicant: CHANCE LINE INDUSTRIAL CO., LTD., Siansi Township (TW)

(72) Inventor: Ming-Hsien YAO, Siansi Township (TW)

(21) Appl. No.: 18/931,621

(22) Filed: Oct. 30, 2024

Related U.S. Application Data
(63) Continuation-in-part of application No. 18/883,359, filed on Sep. 12, 2024.

(51) Int. Cl. B32B 27/06; B32B 3/30; B32B 7/06; B32B 7/12; B32B 27/32; B32B 27/36; B32B 29/00

(52) U.S. Cl. CPC B32B 27/06; B32B 3/30; B32B 7/06; B32B 7/12; B32B 27/32; B32B 27/36; B32B 29/002; B32B 2255/10; B32B 2255/12; B32B 2255/20; B32B 2255/26; B32B 2307/4023; B32B 2307/412; B32B 2307/414; B32B 2307/748; B32B 2307/75; B32B 2554/00

(57) ABSTRACT

A flexible sheet with graphic, comprising: a flexible sheet material and a graphic, the graphic is a multi-layered structure cut into a shape, comprising: a first adhesive layer; a printing layer printed with a pattern, the printing layer is bonded with the first adhesive layer; and a covering film comprising a transparent or translucent surface film layer and a second adhesive layer, the surface film layer is bonded with the printing layer by the second adhesive layer and covers the printed pattern. The graphic is adhered onto the sheet material with the first adhesive layer, and the graphic and the pattern are capable of remaining intact and withstanding water washing.

### FIELD OF THE INVENTION

The invention relates to a flexible sheet such as cloth, leather, and plastic film, more particularly to a flexible sheet formed with a graphic.

### DESCRIPTION OF THE RELATED ART

Printable heat transfer vinyl is available on the DIY market for the public to purchase. Users can print on the heat transfer vinyl and cut out a graphic from the heat transfer vinyl, and then adhere the graphic onto clothes through heating. In this way, the clothes can have unique graphics and create a unique look that is different from others.

In order to increase people's desire to purchase, heat transfer vinyl manufacturers will produce a variety of heat transfer vinyls and display them in shopping malls for the public to choose from, such as heat transfer vinyls of various colors, backgrounds or textures.

However, producing various styles of heat transfer vinyls will cause many problems, such as: more styles and varieties of heat transfer vinyls require more inventory and inventory space, and some of the heat transfer vinyls will be unsaleable and unpopular, resulting in a cost burden for the manufacturers. In addition, the more styles of heat transfer vinyls produced, the less environmentally friendly to Earth.

In addition, for printable heat transfer vinyls on the DIY market, people use EPSON, HP and other household printers at home to print graphics with dye ink on the printable heat transfer vinyls, or use laser printers to print toner on the printable heat transfer vinyls. The ink or toner of such type of graphics formed by the heat transfer vinyls on the surfaces of clothes by hot ironing is loosely adhered on the fibers of the clothes, and the ink or toner is not resistant to washing in water. After two or three times of washing in water, the ink or toner on the graphics will fall off, diffuse or scatter, causing the graphics to be incomplete or damaged, and the colors will fade and become less vivid. After all, the main purpose of household printers is for printing on paper, not on clothing. When the graphics are incomplete and the colors are not vivid, people will be reluctant to continue wearing the clothes, and it is difficult to completely remove the graphics from the clothes. Eventually, people discard the clothes due to the damaged and inaesthetic graphics, resulting in waste.

### SUMMARY OF THE INVENTION

One object of the invention is to provide a flexible sheet with a graphic, the graphic on the sheet and a pattern of the graphic are capable of withstanding water washing, remaining intact and maintaining vivid colors.

One object of the invention is to provide a flexible sheet with a graphic, a pattern of the graphic can be customized or made by DIY. Only a few styles of products are needed to make the graphic, which can significantly reduce a number of products used to make the graphic and an inventory thereof, which is environmentally friendly and can reduce waste.

The invention provides a flexible sheet with a graphic, comprising:
a sheet material with flexibility and being cloth, leather, plastic film, paper, wood flake or metal flake;
a graphic being a multi-layered structure cut into a shape, comprising:
a first adhesive layer;
a printing layer, a pattern is printed on the printing layer, one surface of the printing layer is bonded with the first adhesive layer, the pattern is located on another surface of the printing layer; and
a covering film comprising a transparent or translucent surface film layer and a second adhesive layer, the surface film layer is bonded with the another surface of the printing layer by the second adhesive layer and covers the printed pattern;
the graphic is adhered onto the sheet material by the first adhesive layer.

Thereby, consumers or merchants can make the graphics with a variety of the patterns on the flexible sheet, the graphic is capable of withstanding water washing, the graphic and the pattern thereof are capable of remaining intact.

Preferably, the first adhesive layer is a hot melt adhesive layer, the graphic is adhered onto the sheet material by using the hot melt adhesive layer to produce viscosity when being heated.

Preferably, one surface of the surface film layer of the covering film is bonded with the second adhesive layer, and another surface is a textured surface with a concave-convex texture or a texture that forms a laser effect, the texture with the laser effect is capable of forming a surface effect similar to that of a laser treatment or a 2D/3D effect.

Preferably, the covering film comprises a zinc sulfide layer bonded with one surface of the surface film layer, the zinc sulfide layer causes a light refracted or reflected from the surface film layer to have an iridescent (colorful) effect.

Preferably, the covering film comprises a metal layer bonded with one surface of the surface film layer, the metal layer is only partially bonded with the surface film layer, so that the surface film layer forms a partially transparent and partially opaque bronzing film/foil film/gilding film.

Preferably, the surface film layer of the covering film is added with pearlescent powder, glitter powder or luminous powder, the pearlescent powder gives the surface film layer an iridescent effect, the glitter powder gives the surface film layer a metallic luster, the luminous powder gives the surface film layer a luminous effect.

Preferably, the surface film layer is added with a thermochromic pigment to form a transparent or translucent thermochromic layer, thereby a color of the surface film layer can be changed through changes in temperature.

Preferably, the surface film layer is added with a photochromic pigment to form a transparent or translucent photochromic layer, thereby a color of the surface film layer can be changed through irradiation of ultraviolet light or lights of other frequencies.

Preferably, one surface of the surface film layer is provided with micro optical components, including: micro convex lenses, micro concave lenses, and micro convex or concave water droplet-shaped components, so that the surface film layer produces light reflection and refraction effects.

Preferably, the surface film layer is a transparent or translucent light-reflective layer with a light-reflective component, such as micro glass beads capable of reflecting lights. Further, the surface film layer is a light-reflective layer coated or plated with a zinc sulfide capable of producing an iridescent (colorful) effect. The zinc sulfide is disposed on one surface of the light-reflective component.

Preferably, the surface film layer is added with an anti-ultraviolet additive, the surface film layer is capable of resisting sunlight and anti-ultraviolet.

### BRIEF DESCRIPTION OF DRAWINGS

The objects, features, and achieved efficacies of the invention can be understood from the description and drawings of the following preferred embodiments, in which:

FIG. 1 is a cross-sectional view of a flexible sheet with a graphic according to a preferred embodiment of the invention.

FIG. 1A is a cross-sectional view of the flexible sheet according to another preferred embodiment of the invention.

FIG. 2 is a cross-sectional view of a thermal transfer material of the graphic of the invention.

FIG. 3 is a cross-sectional view of a covering film of the graphic of the invention.

FIGS. 4 to 7 are cross-sectional views of the covering film according to several embodiments of the invention, a release layer is omitted in the figures, wherein FIG. 5A is a top view of FIG. 5, and FIG. 5B is an actual object of the covering film in FIG. 5.

FIGS. 8 and 9 are cross-sectional views of the covering film according to another two embodiments of the invention.

FIGS. 10A to 16B show a manufacturing process for forming the graphic on the flexible sheet.

FIG. 17 shows a finished product of the flexible sheet according to a preferred embodiment of the invention.

FIGS. 18 to 29B show another manufacturing process of forming the graphic on the flexible sheet.

FIG. 30 shows a finished product of the flexible sheet according to another preferred embodiment of the invention.

FIG. 31 is a cross-sectional view of the flexible sheet of FIG. 30.

FIG. 32 shows a finished product of the flexible sheet according to another preferred embodiment of the invention.

FIGS. 33 to 36 show a finished product of the flexible sheet according to another preferred embodiment of the invention.

FIGS. 37 to 44 show a finished product of the flexible sheet according to other preferred embodiments of the invention.

### DETAILED DESCRIPTION OF THE INVENTION

The invention relates to a flexible sheet with a graphic. Consumers or merchants, such as sporting goods stores, clothing stores, leather goods stores, bag stores, etc., can use a technique disclosed in the invention to form a graphic with a pattern on various kinds of flexible sheets by themselves. The flexible sheet can be cloth, leather, plastic film, paper, wood chip, etc. The cloth can be various fabrics or non-woven fabrics, used in various apparel, clothing, bags, such as but not limited to, various men's or women's clothes, various pants and trousers, socks, shoes, headscarves, scarves, bags, backpacks, handbags, etc.

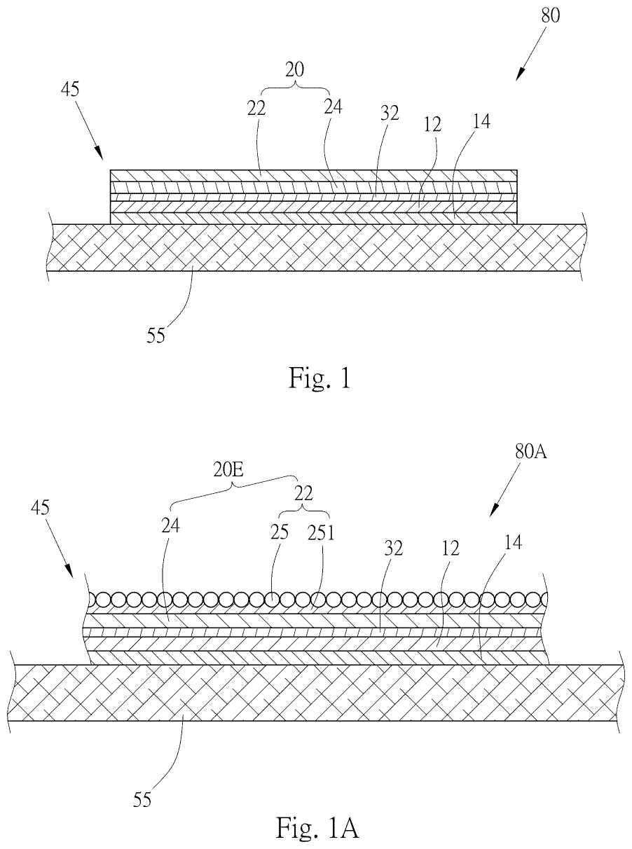

FIG. 1 shows a flexible sheet 80 with a graphic according to a preferred embodiment of the invention, which comprises a flexible sheet material 55, and a graphic 45 disposed on the sheet material 55. The graphic 45 is a multi-layered structure, which is cut into a required shape and adhered to a surface (outer surface) of the sheet material 55. The graphic 45 has a pattern formed by printing. The flexible sheet material 55 in this specification takes cloth as an example, but it can be leather, plastic film, plastic sheet, metal flake, paper or wood flake. The graphic 45 comprises a printing layer 12, a first adhesive layer 14, and a covering film 20, and it is bonded to the flexible sheet material 55 with the first adhesive layer 14. Any suitable adhesive that allows the graphic 45 to be bonded to the flexible sheet material 55 without falling off may serve as the first adhesive layer. In the embodiment, the first adhesive layer is a hot melt adhesive layer. The covering film 20 comprises a transparent or translucent surface film layer 22 and a second adhesive layer 24. The printing layer 12, the hot melt adhesive layer 14 and the covering film 20 of the graphic 45 have a same cutting shape. The surface film layer 22 of the covering film 20 covers the pattern of the printing layer 12, and the surface film layer 22 can become a functional layer and provide different types of decorative effects or surface effects to increase an aesthetics or exterior effects of the graphic 45, for example, one surface of the surface film layer 22 has a concave-convex texture surface, which can provide a concave-convex texture or a laser effect texture, or a 2D/3D effect texture. Alternatively, the surface film layer 22 has an iridescent (colorful) effect or a metallic luster, or the surface film layer 22 has a light-reflective or luminous function, or the surface film layer 22 has a temperature sensation (temperature change) or light sensation (brightness change) effect.

The following describes a process of forming the graphic 45 on the sheet material 55 and a technical means for the surface film layer 22 to form a decorative effect or a surface effect.

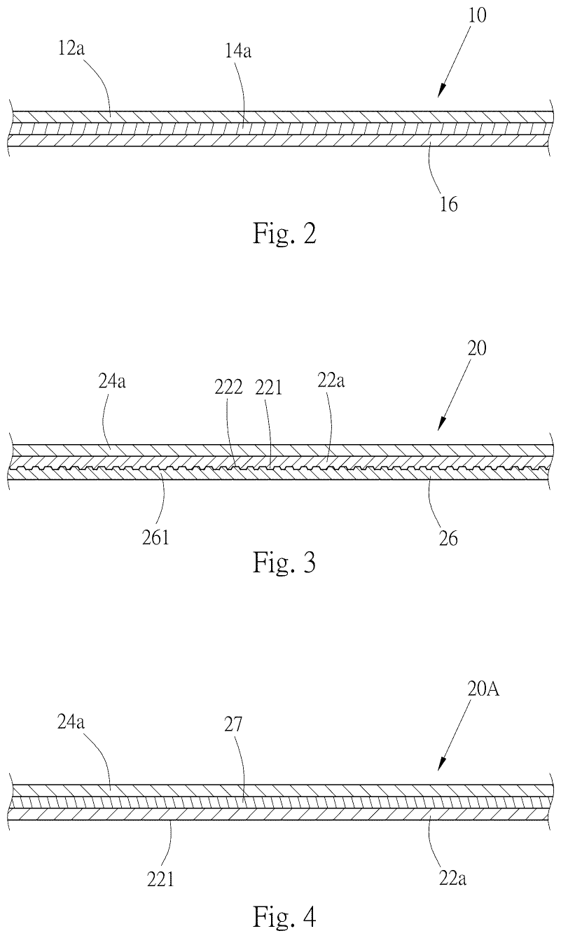

Please refer to FIGS. 2 and 3, which are cross-sectional views of a printable thermal transfer material 10 and an uncut covering film 20. The printable thermal transfer material 10 and the covering film 20 are products made by the applicant for making the graphic 45. The thermal transfer material 10 comprises an uncut printing layer 12 and a hot melt adhesive layer 14 bonded to one surface (inner surface) of the printing layer 12, the printing layer 12 and the hot melt adhesive layer 14 are disposed together on a carrier layer 16, and the hot melt adhesive layer 14 is located between the printing layer 12 and the carrier layer 16. Ink or toner can be used to print a pattern on another surface (outer surface) of the printing layer 12 through an inkjet printer or a laser printer. The heat transfer material 10 disclosed in the embodiment of the invention is a water-based heat transfer material, which is environmentally friendly to Earth. A material of the printing layer 12 is not limited to that shown in the embodiment. A material of the carrier layer 16 can be paper or high molecular polymer, and preferably has release properties. The printing layer 12 and the hot melt adhesive layer 14 can be peeled off from the carrier layer 16 together.

The covering film 20 is a special film material provided by the invention, and comprises the surface film layer 22 and the second adhesive layer 24 bonded with one surface of the surface film layer 22, and another surface 221 of the surface film layer 22 is bonded with a release layer 26. The surface film layer 22 and the second adhesive layer 24 have not been cut yet. The release layer 26 is made of PET (polyethylene terephthalate) or CPP (cast polypropylene), or the release layer 26 can be paper or made of paper. The surface film layer 22 is a transparent or translucent layer, for example, a polymer film, such as a PU (polyurethane) film, but is not limited thereto. As shown in FIG. 2, the surface film layer 22 is formed by coating liquid PU on the release layer 26. The second adhesive layer 24 is a transparent adhesive layer, preferably a thermal adhesive layer, which produces viscosity when being heated. In a preferred embodiment of the invention, the second adhesive layer 24 is a transparent hot melt adhesive, which can be a hot melt adhesive of PP, TPE (thermoplastic elastomer), TPU (thermoplastic polyurethane), PES (polyethersulfone) or EVA (ethylene vinyl acetate), and is provided on the other surface 221 of the surface film layer 22 by coating or attaching.

Please refer to FIG. 3. One surface of the release layer 26 can be made into an embossed surface 261 with a texture, for examples, various concave-convex textures, such as a micro concave-convex texture, preferably a micro concave-convex texture, and the concave-convex texture can be a regular or an irregular texture, comprising, but not limited to, a dotted or striped texture. After the surface film layer 22 is coated on the embossed surface 261 and formed, a surface of the surface film layer 22 in contact with the embossed surface 261 forms a processed or specially produced textured surface 221 with a texture 222 having concave-convex embossed textures. The texture 222 is a texture mirrored on the texture surface 261. The surface film layer 22 and the second adhesive layer 24 can be peeled off from the release layer 26 together.

Alternatively, the texture 222 of the textured surface 221 of the surface film layer 22 has a transparent laser effect exteriorly, that is, the textured surface 221 presents a surface effect similar to that of a laser treatment or a 2D/3D visual effect. The texture 222 can be formed through the embossed surface 261 of the release layer 26.

Alternatively, FIG. 4 shows another embodiment of the covering film. One surface of a surface film layer 22a of a covering film 20A is plated with a zinc sulfide layer 27, so that a light refracted or reflected by the surface film layer 22a has an iridescent (colorful) effect, that is, the light refracted or reflected from the surface film layer 22a is a colorful light. The zinc sulfide layer 27 is located between the surface film layer 22a and an adhesive layer 24a.

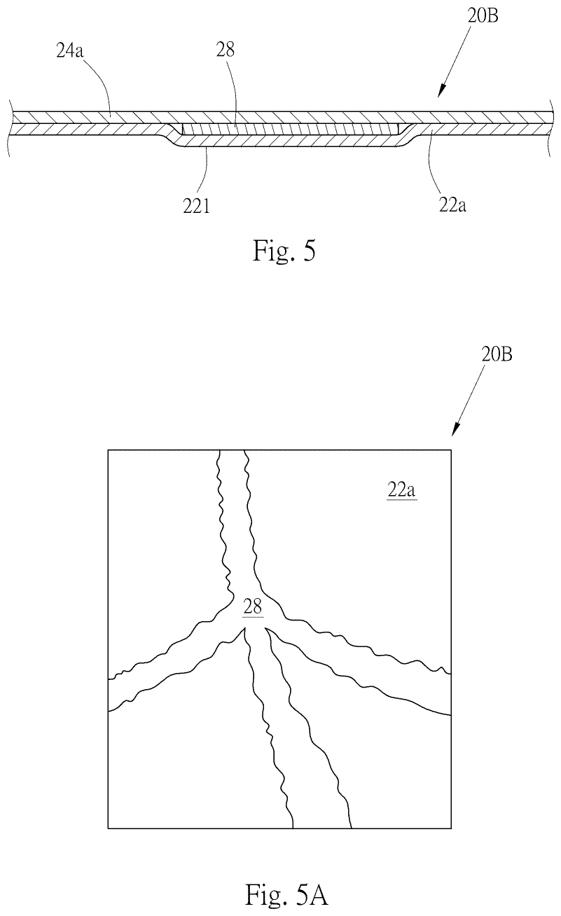

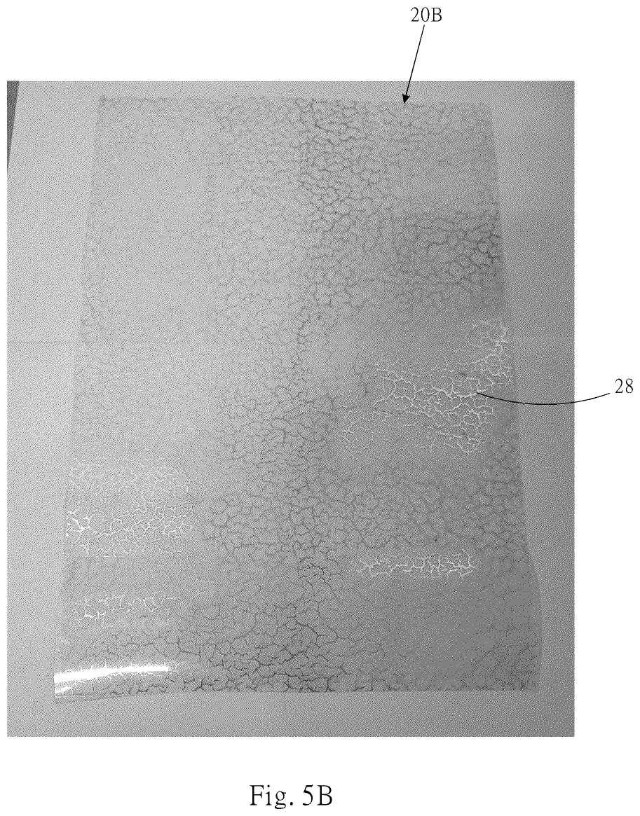

Alternatively, FIGS. 5, 5A and 5B show another embodiment of the covering film. A metal layer 28 is provided on one surface of a surface film layer 22b of a covering film 20B. The metal layer 28 can be a chromium plating layer, an aluminum plating layer, or other suitable metal layers, disposed on one surface of the surface film layer 22 by plating or coating, and located between the surface film layer 22 and the second adhesive layer 24, so that the surface film layer 22 forms a foil (hot stamping foil) film/gilding film. Please refer to FIGS. 5A and 5B, which are top views of the covering film 20B, showing only the surface film layer 22 and the metal layer 28. The metal layer 28 is only disposed on a partial surface of the surface film layer 22 and does not cover the entire surface film layer 22. Therefore, parts of the surface film layer 22 that are not covered by the metal layer 28 remain transparent or translucent to display the pattern on the heat transfer material 10. The metal layer 28 can be regularly or irregularly shaped, including dotted and striped shapes. FIGS. 5A and 5B illustrate a shape of the metal layer 28, but is not limited thereto.

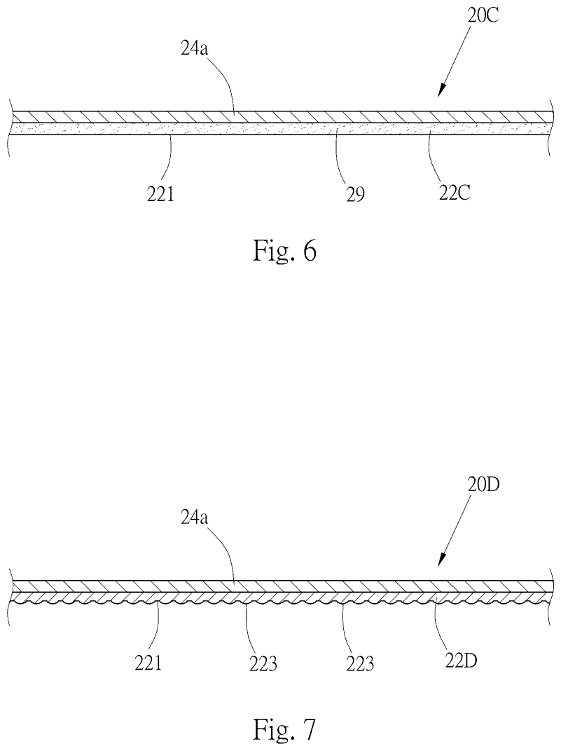

Alternatively, FIG. 6 shows another embodiment of the covering film. A surface film layer 22C of a covering film 20C is mixed with an additive 29 in a weight ratio of 1˜5%. The additive 29 can be pearlescent powder, glitter powder (micro aluminum foil with colors) or luminous powder (luminous particles). The pearlescent powder causes the surface film layer 22C to have an iridescent (colorful) effect. The glitter powder gives the surface film layer 22C a metallic luster, and different colors of glitter powder produce different colors of metallic luster. The luminous powder makes the surface film layer 22C have a luminous effect and capable of emitting light at night.

Alternatively, the additive 29 of the surface film layer 22C is a thermochromic pigment, which makes the surface film layer 22C a transparent or translucent thermochromic film, so that a surface thereof is capable of changing color through changes in temperature.

Alternatively, the additive 29 of the surface film layer 22C is a photochromic pigment, which makes the surface film layer 22C a transparent or translucent photochromic film, so that a surface thereof is capable of producing changes in color through irradiation of a light of a specific frequency, such as UV light.

Alternatively, the additive 29 of the surface film layer 22C is a fragrance, so that the surface film layer 22C has a fragrance to give a good smell, and even a fragrance with a mosquito repellent effect can be used.

Alternatively, the additive 29 of the surface film layer 22C is an anti-ultraviolet additive, making the surface film layer anti-ultraviolet and being capable of resisting sunlight.

Please refer to FIG. 7. Alternatively, the textured surface 221 of a surface film layer 22D of a covering film 20D forms a micro optical structure provided with micro or tiny optical components, such as micro convex lenses 223 or concave lens, or micro water droplet-shaped components (referred to as small water droplets). Preferably, the convex lenses 223, concave lenses or small water droplets are formed by the embossed surface 261 of the release layer 26. Each of the convex lenses 223 is a convex structure, protruding from the textured surface of the surface film layer 22D; each of the concave lenses is a concave structure, recessed from the textured surface 221 of the surface film layer 22D; each of the small water droplets can be a convex or concave structure. Through the convex lenses 223, the concave lenses or the small water droplets, the surface of the surface film layer 22D produces light reflection and refraction effects.

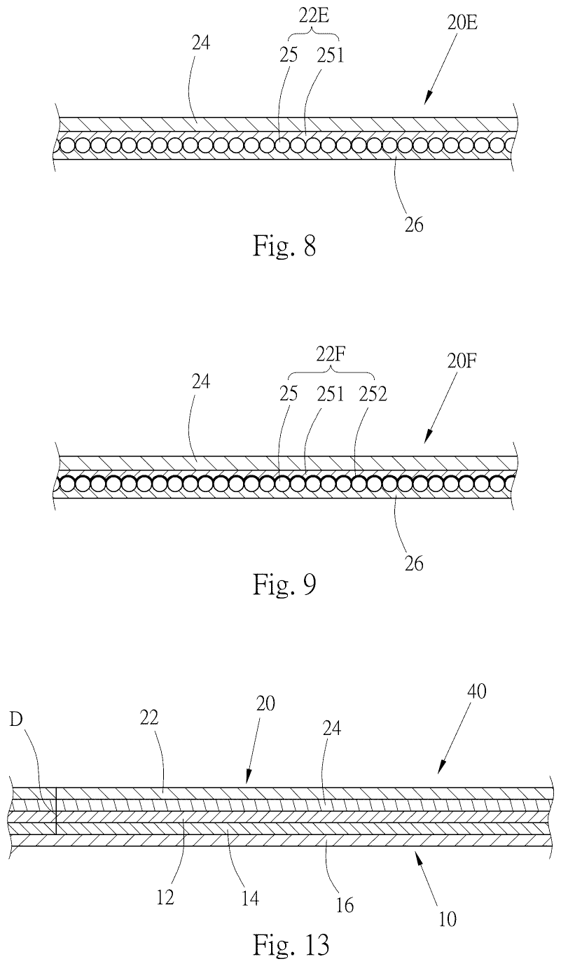

Alternatively, a surface film layer 22E of a covering film 20E is a layer of transparent or translucent light-reflective component. The covering film 20E in FIG. 8 uses a transparent or translucent light-reflective layer 25 as the surface film layer 22E. The light-reflective layer 25 is a layer of micro glass beads. One surface of the micro glass bead layer 25 is bonded to the second adhesive layer 24 with a layer of transparent glue or adhesive 251. The release layer 26 is provided on another surface of the micro glass bead layer 25. The surface film layer 22E and the second adhesive layer 24 can be separated from the release layer 26 together.

Alternatively, FIG. 9 shows another preferred embodiment of the covering film. A covering film 20F has a transparent or translucent surface film layer 22F, the second adhesive layer 24 and the release layer 26. The surface film layer 22F comprises a micro glass bead layer 25, a layer of the transparent or translucent glue or adhesive 251, and a zinc sulfide layer 252. The zinc sulfide layer 252 is coated or plated on a surface (inner surface) of the micro glass bead layer 25, located between the micro glass bead layer 25 and the second adhesive layer 24. The adhesive 251 is TPU, PUR (polyurethane reactive) or acrylic series hot melt adhesive. The micro glass bead layer 25 of the surface film layer 22F is capable of reflecting a light, and through the zinc sulfide layer 252, the reflected light has an iridescent effect. The surface film layer 22F and the second adhesive layer 24 can be separated from the release layer 26 together.

In the embodiment disclosed in this specification, the surface film layers 22 and 22F with the zinc sulfide layers 27 and 252 and the surface film layer 22C with pearlescent powder or glitter powder added are translucent film materials. The surface film layer 22 in FIG. 3, the surface film layer 22 with the metal layer 28 in FIG. 5, and the surface film layers 22D and 22E in FIGS. 7 and 8 can be transparent or translucent film materials.

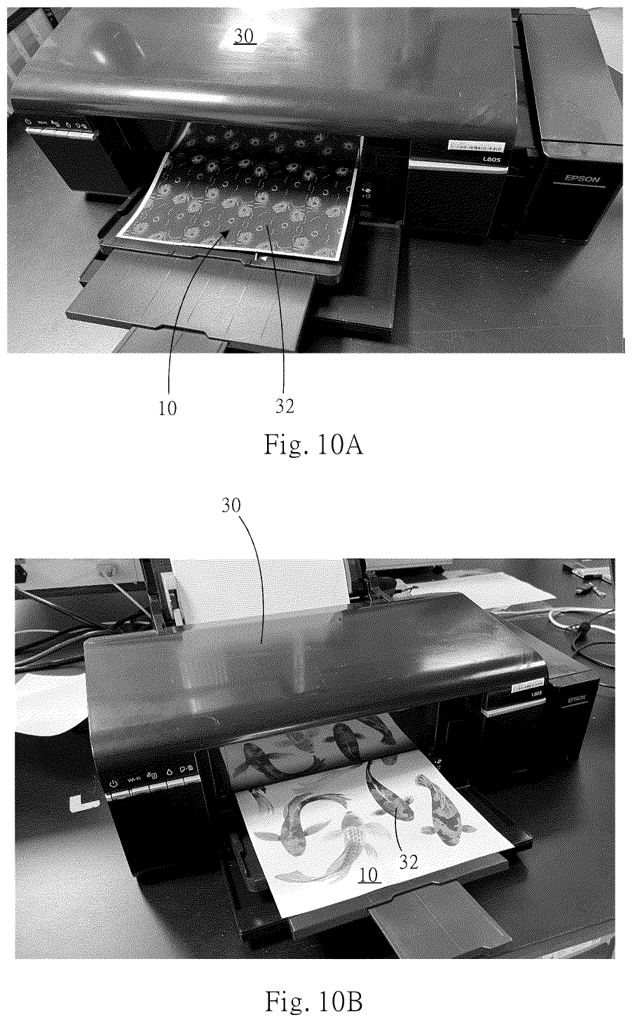

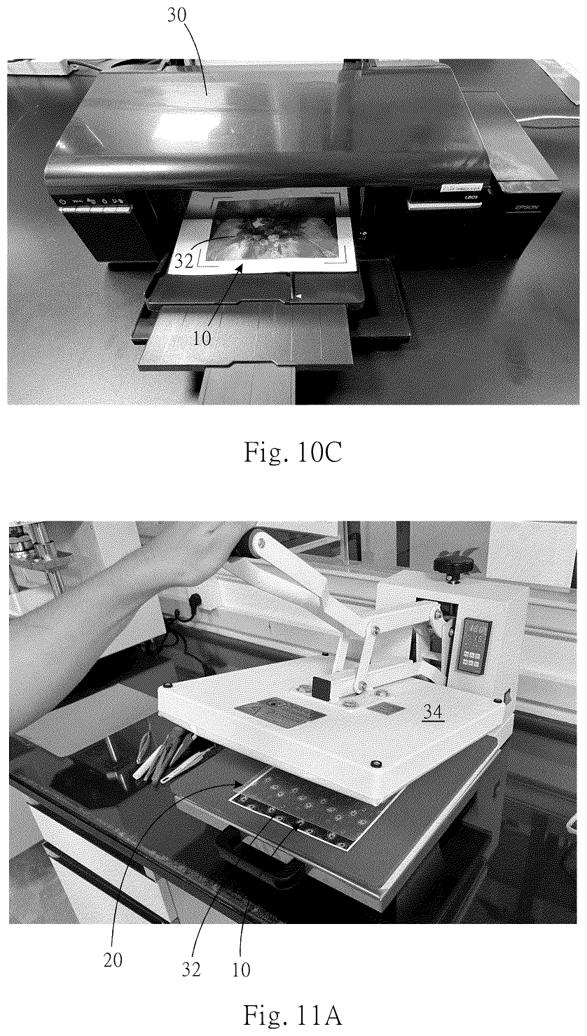

FIGS. 10A to 17 show a manufacturing process for producing the flexible sheet 80 with a pattern as shown in FIG. 1. The covering film 20 and the surface film layer 22 described below comprise the covering film and the surface film layer shown in the embodiments of FIGS. 3 to 9.

Firstly, printing a pattern 32 on the printing layer 12 of the printable thermal transfer material 10 shown in FIG. 2;

Computer printing is a printing technology that can be implemented by ordinary households. FIGS. 10A to 10C show that through computer printing consumers use a household printer 30 of EPSON or HP brand to print a pattern 32 onto the printing layer 12 of the heat transfer material 10 by ink or toner. The pattern 32 can be various graphics such as characters, animals, non-characters, non-animals, texts or non-texts, and can be monochromatic or chromatic, preferably chromatic. FIGS. 10A to 10C show three different patterns 32, including a non-animal pattern with feathers in FIG. 10A, a fish pattern in FIG. 10B, and a character pattern in FIG. 10C. Consumers can design and print textures, styles and colors of the pattern 32 by themselves. Ink that can be printed on the printing layer 12 can be dye ink or sublimation ink (also called thermal sublimation ink).

Bonding the covering film 20 shown in FIG. 3 on the printing layer 12 of the printable thermal transfer material 10 to cover the pattern 32.

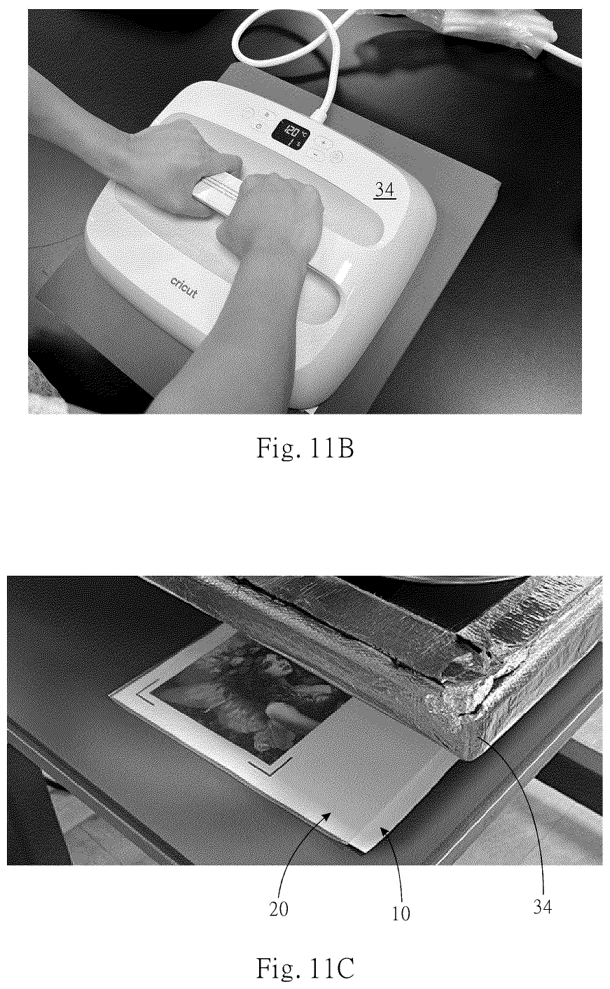

Please refer to FIGS. 11A to 11C, the covering film 20 is placed on the heat transfer material 10, and the covering film 20 is adhered to the printing layer 12 of the heat transfer material 10 with the second adhesive layer 24 to cover the pattern 32. The second adhesive layer 24 is a hot melt adhesive that generates viscosity when being heated. Therefore, consumers can use hot ironing devices they have at home, such as an electric iron or a hot ironing machine 34 shown in FIGS. 11A and 11C to heat the covering film 20 and the heat transfer material 10 to adhere the covering film 20 onto the printing layer 12 through the second adhesive layer (hot melt adhesive) 24 to cover and protect the pattern 32. After the covering film 20 and the heat transfer material 10 are adhered with each other, the release layer 26 of the covering film 20 is peeled off, and only the surface film layer 22 of the covering film 20 is left to adhere on the heat transfer material 10. The surface film layer 22 is adhered on the printing layer 12 to cover the pattern 32 so that the pattern 32 does not come into contact externally.

Cutting the graphic 45 out from the thermal transfer material 10 and the covering film 20 bonded with each other.

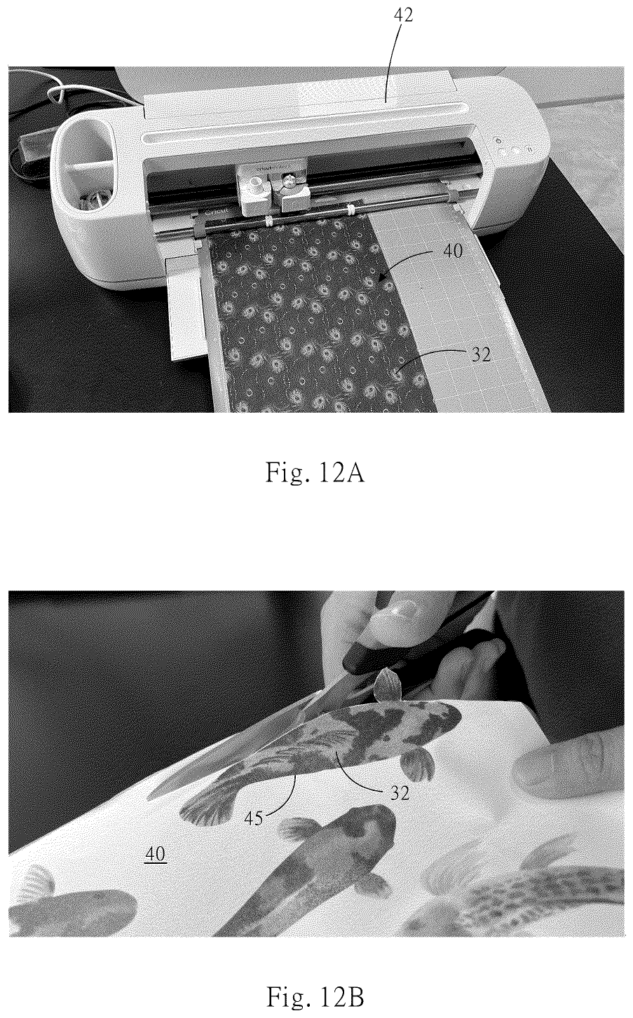

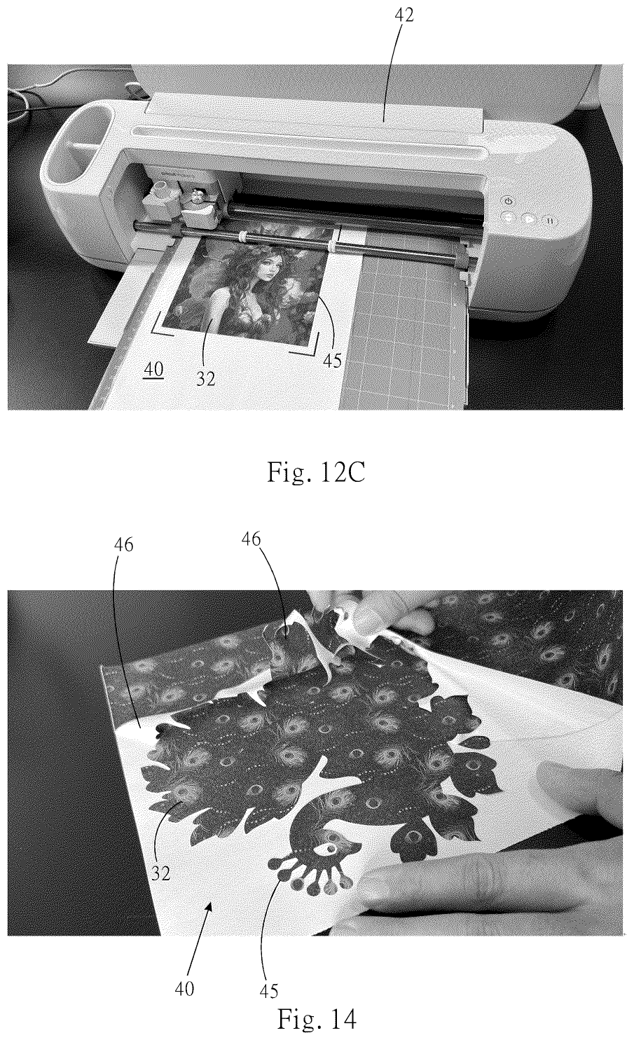

The heat transfer material 10 and the surface film layer 22 of the covering film 20 are laminated to form a laminated film material 40. Then, a graphic is cut out from the laminated film material 40. Please refer to FIGS. 12A to 12C, the graphic is cut out from the laminated film material 40. Consumers can use a household cutting machine 42 as shown in FIGS. 12A and 12C to perform cutting, for example, a CRICUT graphic cutting machine can be used. Alternatively, as shown in FIG. 12B, the graphic can be manually cut out from the laminated film material 40 with a cutting tool such as a utility knife or scissors. The household cutting machine 42 is controlled by a computer to perform pattern cutting. A bird graphic in FIG. 14 is a graphic 45 cut out by the cutting machine 42 in FIG. 12A. Please refer to FIG. 13, a cutting depth D of a cutter of the cutting machine 42 cuts off the surface film layer 22, the second adhesive layer 24, the printing layer 12 with a printing pattern, and the hot melt adhesive layer 14. FIG. 12B shows that the fish graphic 45 is cut out with scissors. FIG. 12C shows the cutting machine 42 cutting out the graphic 45 from the laminated film material 40. The cutting machine 42 cuts out an outline of the pattern 32 and cuts out a rectangular graphic 45.

Then, as shown in FIG. 14, parts other than the graphic 45 are peeled off, that is, a waste material 46 that does not belong to the graphic 45 is peeled off, and only the graphic 45 is retained. The graphic 45 formed by cutting comprises the hot melt adhesive layer 14, the printing layer 12 with the pattern 32 printed on it, the second adhesive layer 24 and the surface film layer 22 of a same shape and stacked together from bottom to top.

Please refer to FIG. 15, using a transfer film 52, and transferring the cut graphic 45 onto the transfer film 52. After the graphic 45 is transferred onto the transfer film 52, the graphic 45 is separated from the carrier layer 16 of the heat transfer material 10. As mentioned above, the printing layer 12 and the hot melt adhesive layer 14 are easily separated from the carrier layer 16. The graphic 45 (comprising the laminated surface film layer 22, the second adhesive layer 24, the printing layer 12 and the hot melt adhesive layer 14) is adhered or attached onto the transfer film 52 after being separated from the carrier layer 16.

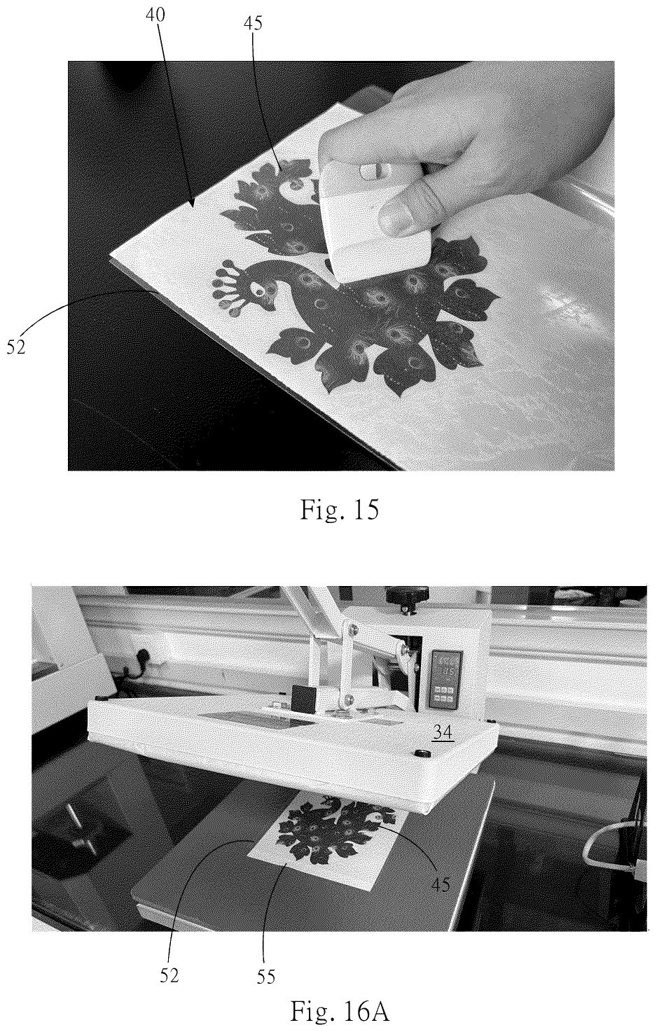

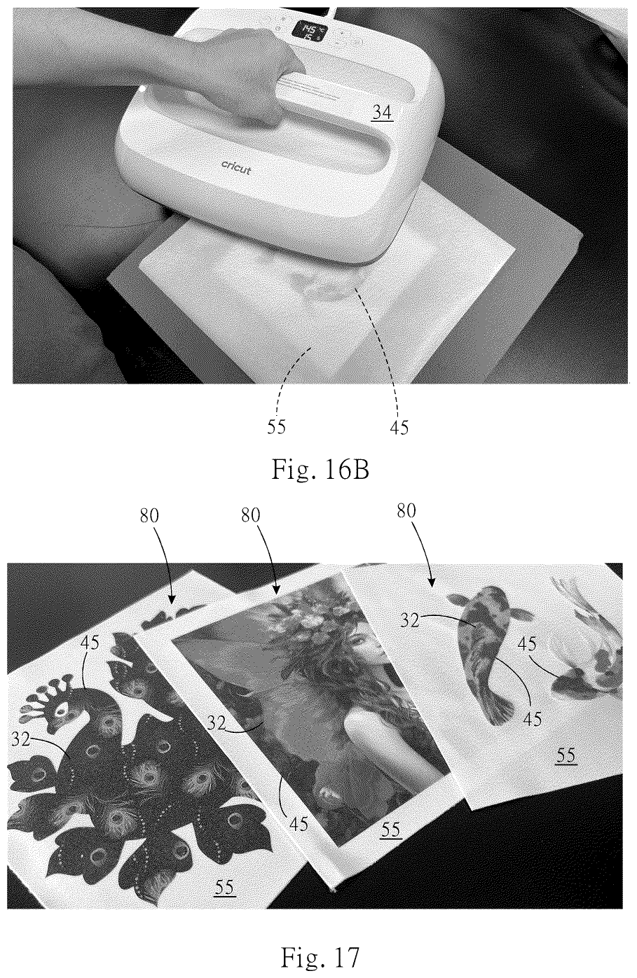

Then, as shown in FIG. 16A and FIG. 16B, the transfer film 52 comprising the graphic 45 is placed on cloth 55, and the hot melt adhesive layer 14 of the graphic 45 contacts the cloth 55. The transfer film 52 and the graphic 45 are heated with an electric iron or a hot ironing machine 34. The hot melt adhesive layer 14 is heated and generates viscosity to adhere the graphic 45 to a surface of the cloth 55, as shown in FIGS. 1 and 17, a flexible sheet 80 with the graphic of the invention is manufactured. The graphic 45 and the pattern 32 of the graphic are covered by the surface film layer 22, and the pattern 32 is isolated by the surface film layer 22.

FIG. 1A shows a cross-sectional view of another flexible sheet 80A with a pattern made according to the above process. When the surface film layer 22 is the surface film layer (22E, 22F) shown in FIG. 8 or FIG. 9, the surface film layer 22 has a light-reflective effect; during the day, the surface film layer 22 does not reflect light; at night, the micro glass bead layer 25 of the surface film layer 22 reflects light, causing the pattern 32 to produce a light-reflective effect.

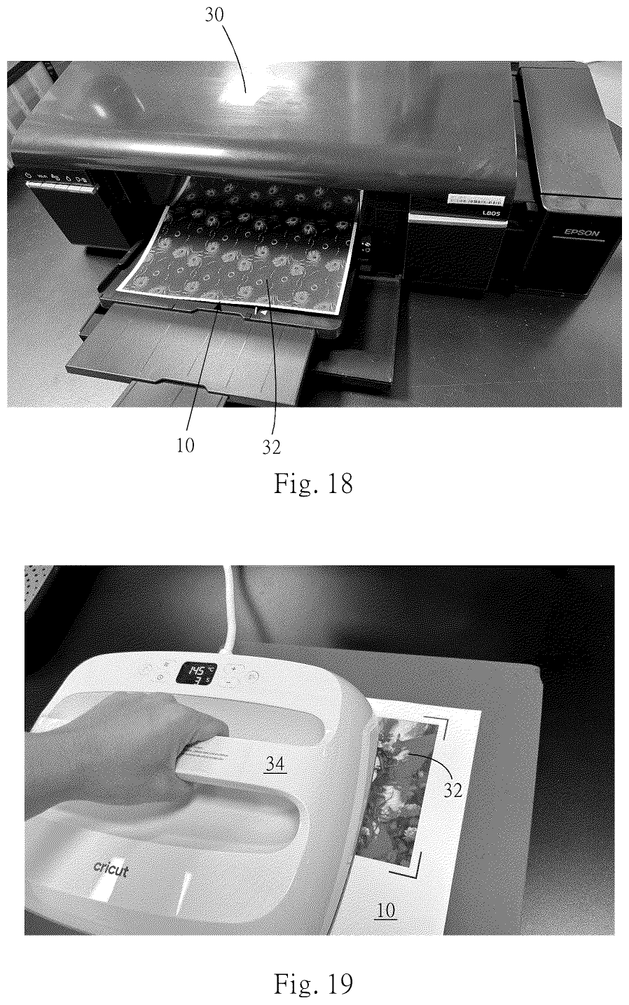

FIGS. 18 to 30 show another process for making the flexible sheet of the invention. The covering film 20 and surface film layer 22 described below comprise the covering film and surface film layer shown in the embodiments of FIGS. 3 to 9.

As shown in FIG. 18, using a home printer 30 to print the pattern 32 on the printing layer 12 of the thermal transfer material 10 through computer printing. The pattern 32 can be various patterns such as characters, animals, non-characters, non-animals, texts or non-texts. This step is the same as the printing steps shown in FIGS. 10A to 10C.

Please refer to FIG. 19. After the pattern 32 is printed, the pattern 32 can be heated with an electric iron or a hot ironing machine 34 to dry the ink of the pattern 32 to shape the pattern 32.

Cutting out a first graphic 60 on the thermal transfer material 10, removing parts other than the first graphic 60, keeping the first graphic 60.

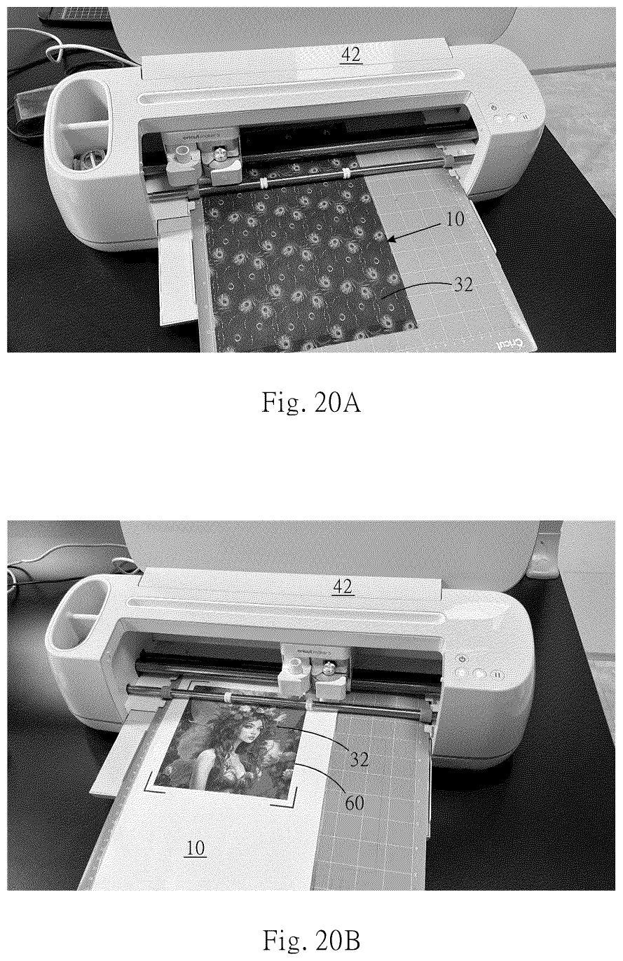

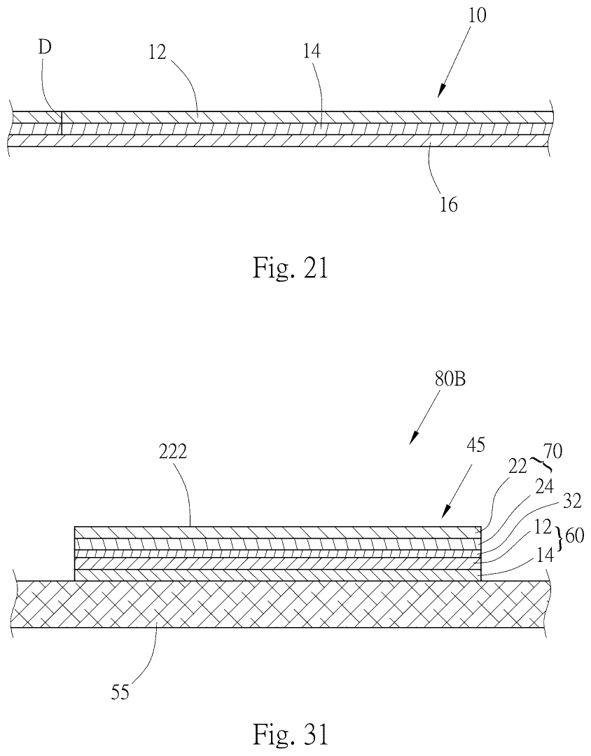

Similar to what is shown in FIG. 12B, the graphic can be manually cut out from the heat transfer material 10 with a utility knife or scissors; or as shown in FIG. 20A or FIG. 20B, the first graphic 60 can be cut out from the heat transfer material 10 with a household cutting machine 42 through a computer. The cutting depth D of the first graphic 60 cuts off the printing layer 12 and the hot melt adhesive layer 14, as shown in FIG. 21.

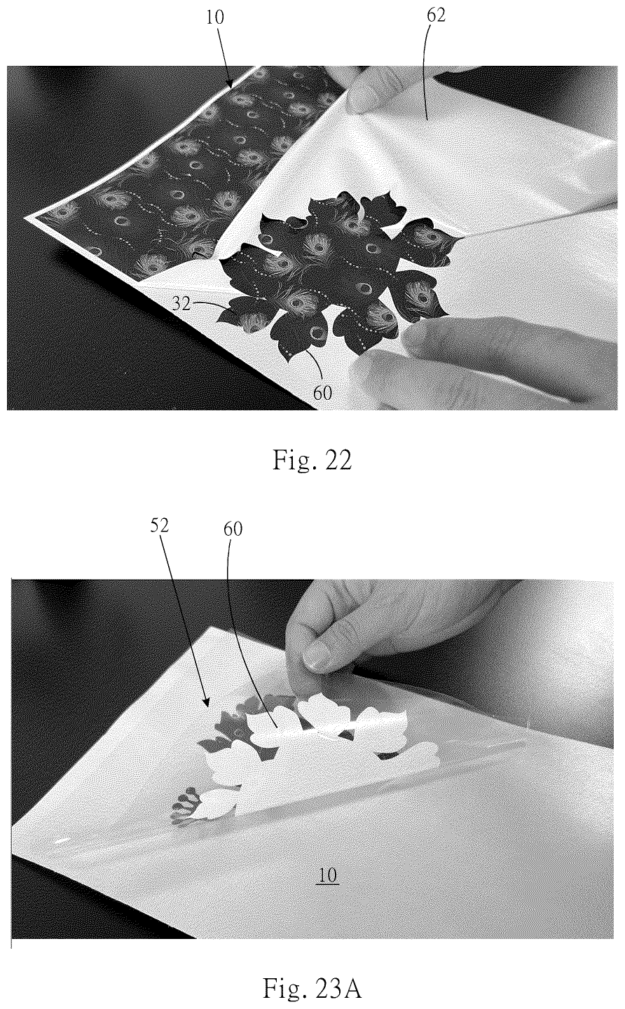

Then, as shown in FIG. 22, parts other than the first graphic 60 are peeled off, that is, a waste material 62 is removed, leaving only the first graphic 60 on the carrier layer 16. At this time, the first graphic 60 comprises the printing layer 12 with the pattern 32 printed thereon and the hot melt adhesive layer 14.

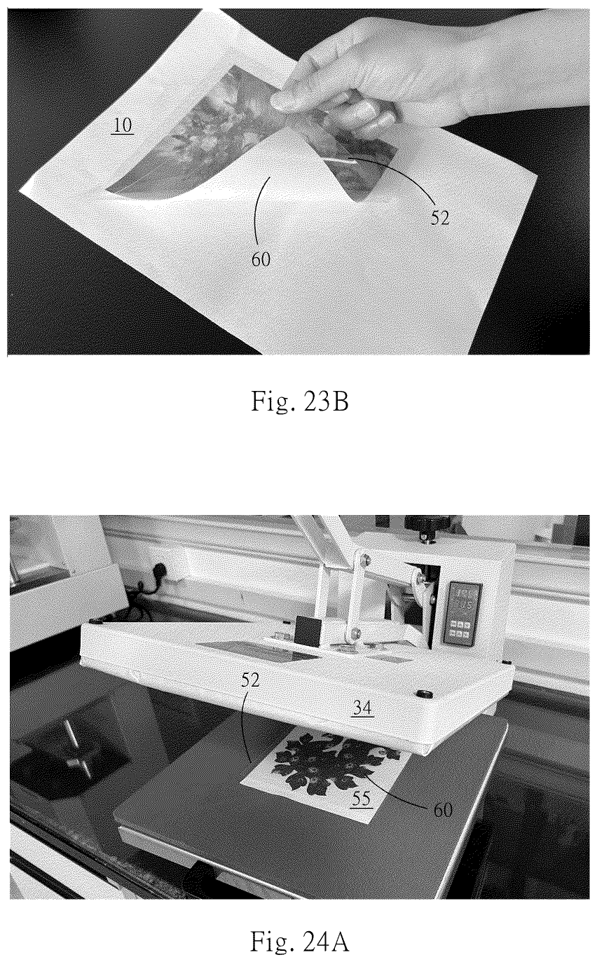

Please refer to FIG. 23A and FIG. 23B, using a transfer film 52, and transferring the cut first graphic 60 onto the transfer film 52. After the first graphic 60 is transferred onto the transfer film 52, the first graphic 60 is separated from the carrier layer 16 of the heat transfer material 10.

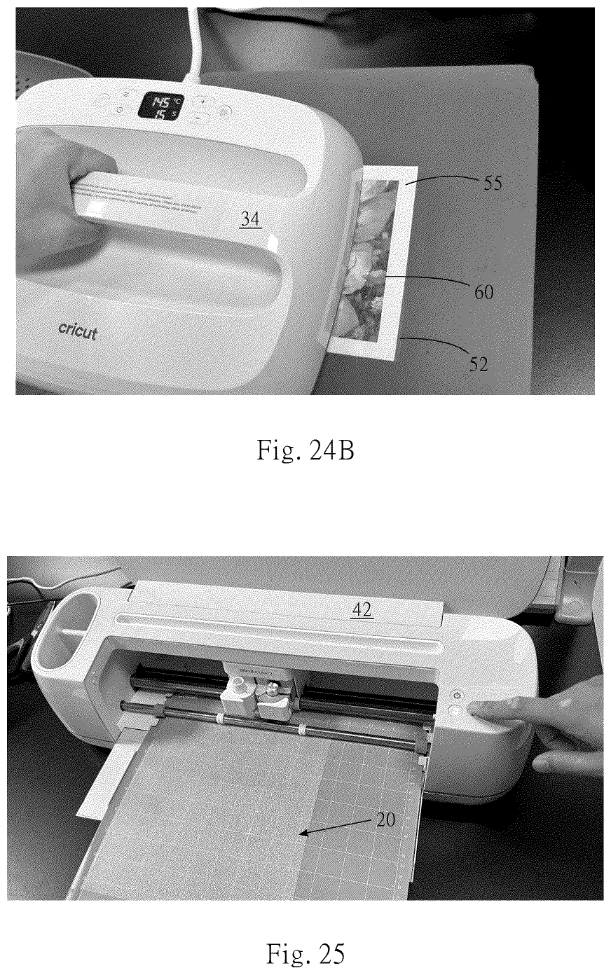

Then, as shown in FIGS. 24A and 24B, the transfer film 52 comprising the first graphic 60 is placed on cloth 55, and the hot melt adhesive layer 14 of the first graphic 60 contacts the cloth 55. The transfer film 52 and the first graphic 60 are heated with an electric iron or a hot ironing machine 34 to adhere the graphic 60 onto the cloth 55 through a viscosity generated by heating the hot melt adhesive layer 14.

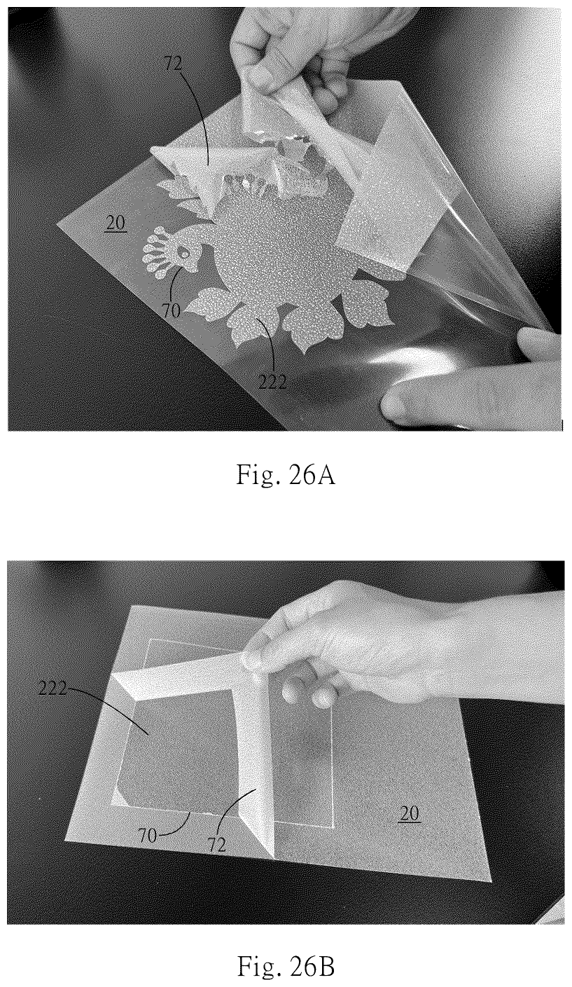

Using the covering film 20 shown in FIG. 3, and cutting out a graphic film 70 from the covering film 20 manually or with a household cutting machine 42 shown in FIG. 25. FIGS. 26A and 26B show the graphic film 70, a shape of the graphic film 70 is the same or approximately the same as a shape of the first graphic 60. Through computer cutting, that is, the cutting machine 42 is controlled by a computer, the graphic film 70 consistent with a shape of the first graphic 60 can be cut. The graphic film 70 having approximately a same shape as that of the first graphic 60 can be cut manually. The graphic film 70 is preferably capable of covering the first graphic 60 completely.

Then, as shown in FIGS. 26A and 26B, parts other than the graphic film 70 are removed, that is, the waste material 72 is removed, so that the covering film 20 only retains the cut graphic film 70. The graphic film 70 comprises the laminated surface film layer 22 and the second adhesive layer 24. It can be seen from FIG. 25 and FIGS. 26A and 26B that a surface of the surface film layer 22 has the micro concave-convex texture 222, making the surface film layer 22 a translucent film. FIGS. 25, 26A and 26B only illustrate the texture 222 of a certain type, which is not intended to be a limitation.

Please refer to FIG. 27, using a transfer film 52, and transferring the graphic film 70 onto the transfer film 52. The graphic film 70 is separated from the carrier layer 16 of the heat transfer material 10. At this time, the graphic film 70 is composed of the surface film layer 22 and the second adhesive layer 24 of the covering film 20 and is attached or adhered onto the transfer film 52. FIG. 27 shows that the graphic film 70 has been transferred onto the transfer film 52.

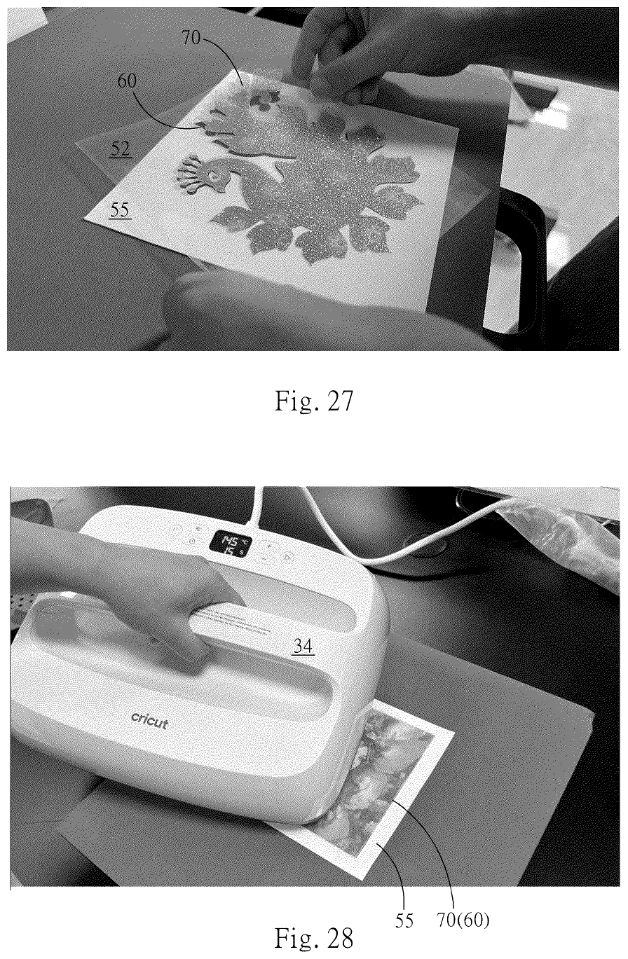

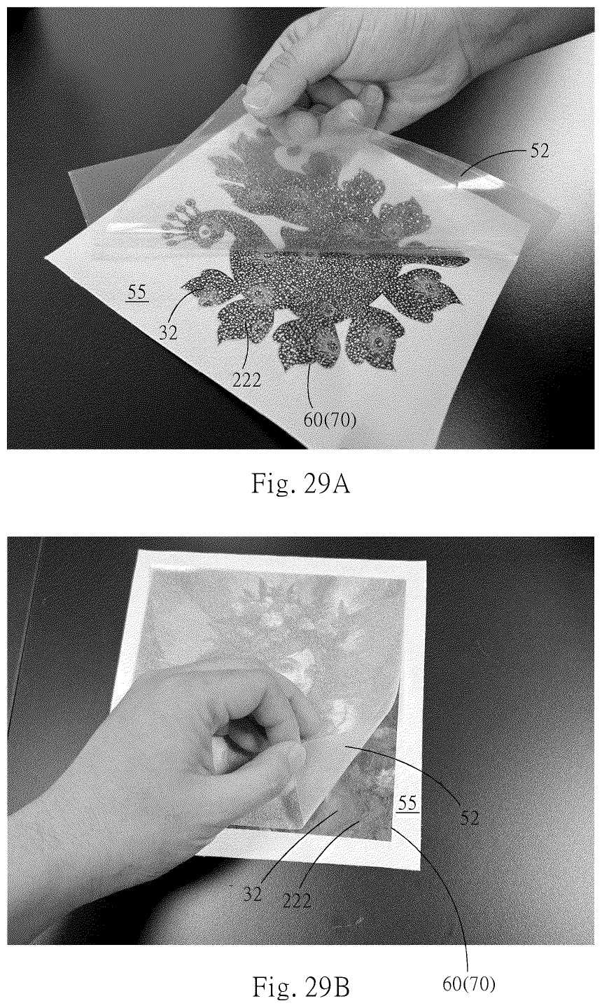

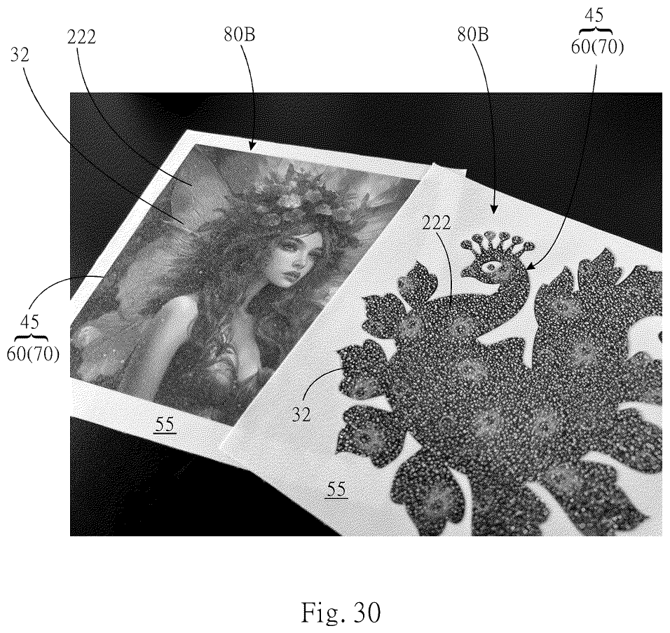

Then, as shown in FIG. 27, align the graphic film 70 with the first graphic 60 on the cloth 55. As shown in FIG. 28, use an electric iron or a hot ironing machine 34 to heat the transfer film 52 and the graphic film 70 to cause the second adhesive layer (hot melt adhesive) 24 to generate viscosity, and to adhere the graphic film 70 onto the first graphic 60. Lastly, as shown in FIG. 29A and FIG. 29B, the transfer film 52 is peeled off to adhere the first graphic 60 and the graphic film 70 onto the cloth 55 to complete the method of the invention. A finished product is shown in FIGS. 30 and 31. The first graphic 60 and the graphic film 70 are adhered onto a surface of the cloth 55, and the graphic film 70 is adhered onto the first graphic 60. The printed pattern 32 on the printing layer 12 is covered and protected by the surface film layer 22, the pattern 32 will not be damaged, and exteriors of the first graphic 60 and the pattern 32 have a texture effect formed by the texture 222 of the surface film layer 22.

FIG. 32 shows a flexible sheet 80C according to another preferred embodiment of the invention, which can be produced by any of the above processes. After being made, the graphic 45 with the pattern 32 is formed on the cloth 55, and the pattern 32 of the graphic 45 is covered by the surface film layer 22. The surface film layer 22 of the flexible sheet 80C has glitter powder, so a surface of the graphic 45 produces a metallic luster effect.

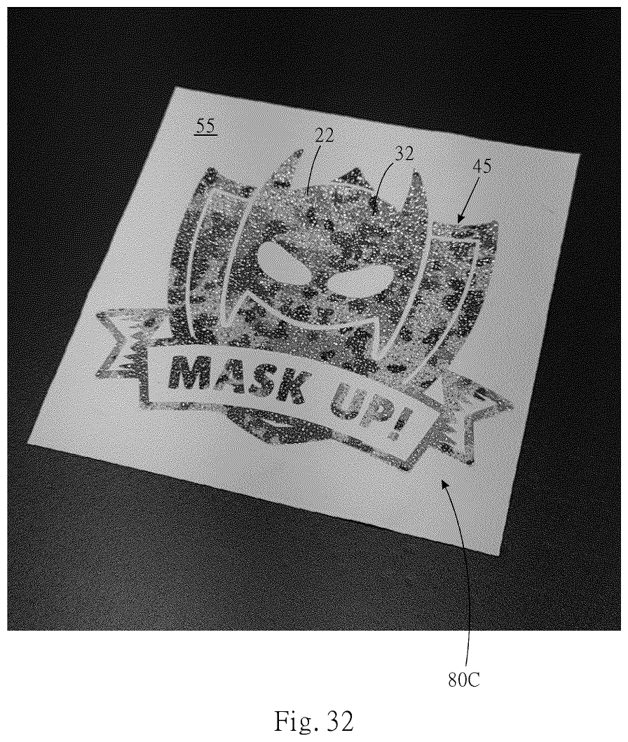

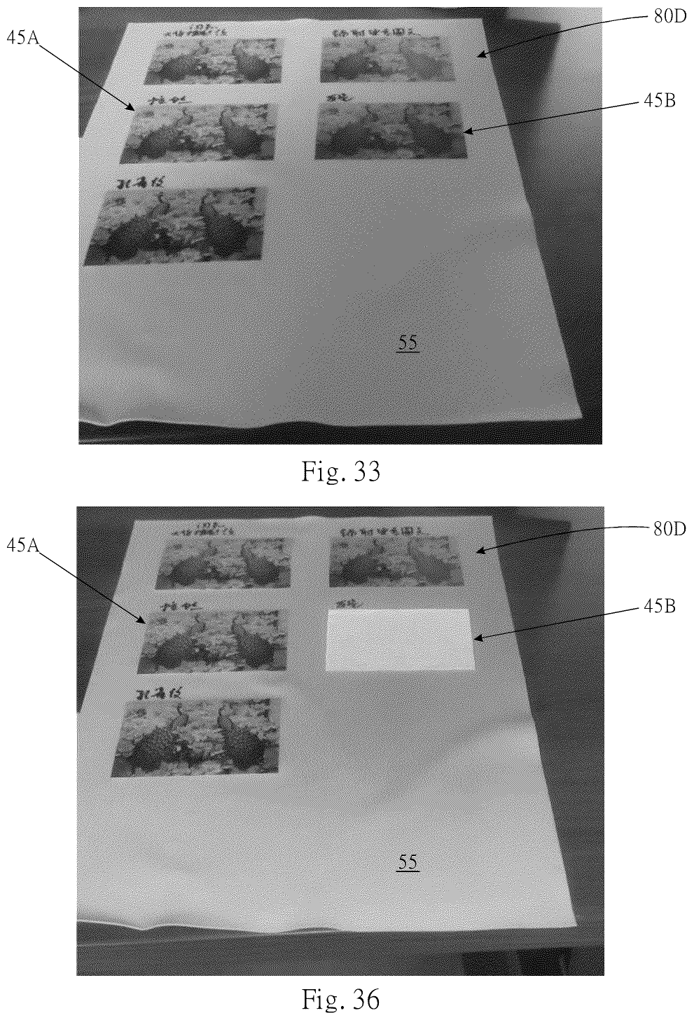

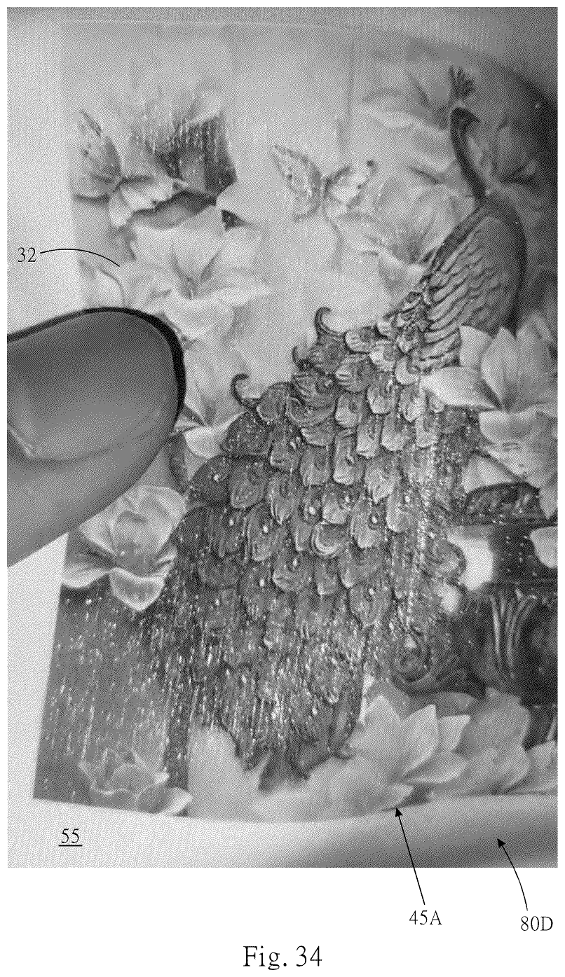

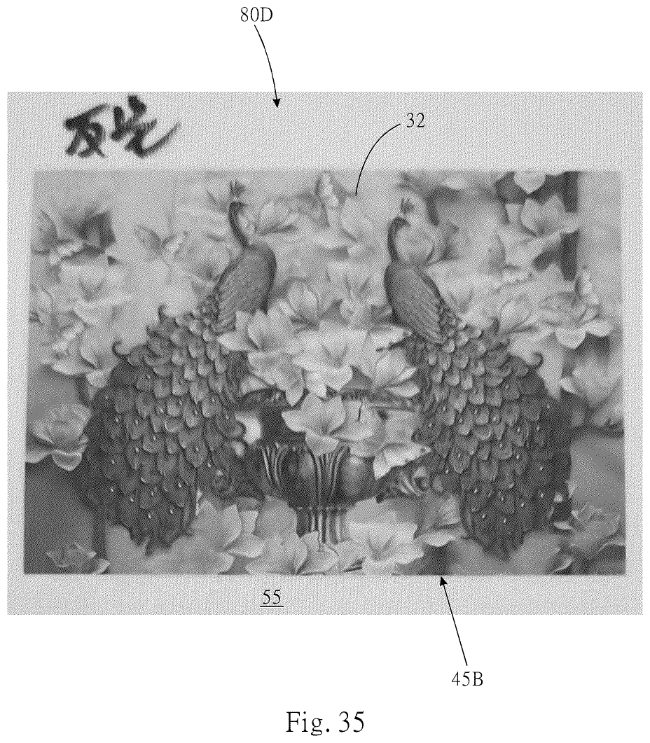

FIGS. 33 to 36 show a flexible sheet 80D according to another preferred embodiment of the invention. The graphics 45 with the peacock pattern 32 are made on the cloth 55. The surface film layer of each of the graphics 45 has a different surface effect, wherein: as shown in FIG. 34, the surface film layer of a graphic 45A has a striped texture; while a structure of a graphic 45B is as shown in FIG. 1A, and the surface film layer thereof is a light-reflective film layer, provided with the micro glass bead layer 25 of FIG. 8 or FIG. 9. As shown in FIGS. 33 and 35, when the graphic 45B is not light-reflective, a pattern of the graphic 45B can be seen. At night or in a dark place, when a light irradiates on the graphic 45B, as shown in FIG. 36, the surface film layer of the graphic 45B will reflect light to provide a function of safety.

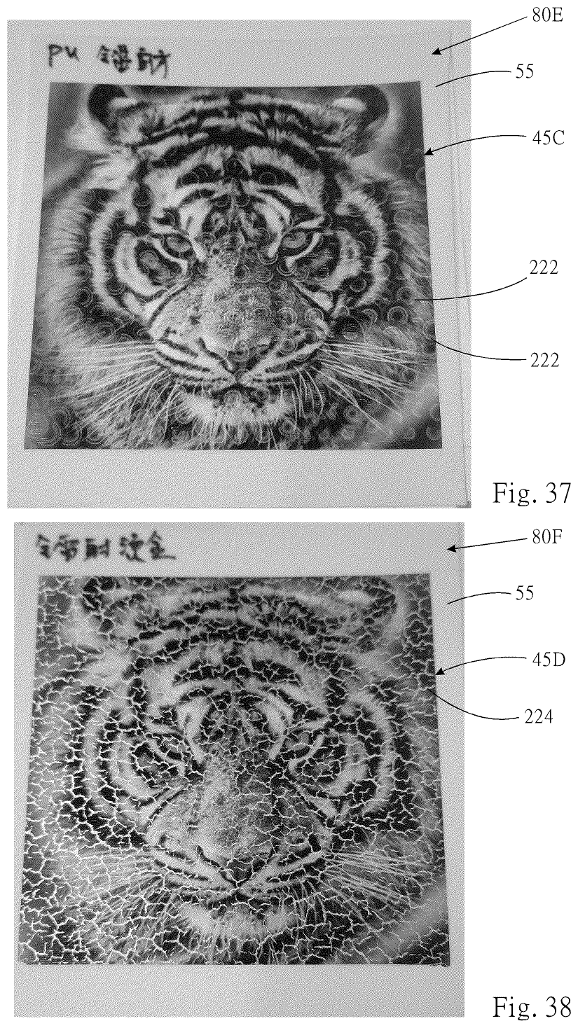

FIGS. 37 to 41 show the flexible sheet of other preferred embodiments of the invention, wherein a texture 222 of a texture surface 221 of the surface film layer of the graphic 45C of a flexible sheet 80E of FIG. 37 is made into a texture with a laser effect to cause the surface film layer to form a laser-treated transparent film, and the graphic 45C produces a laser texture.

A flexible sheet 80F in FIG. 38 is made of the covering film 20B in FIG. 5B, and the surface film layer thereof is a gilding film with the metal layer 28, so that the graphic 45D forms a texture 224 with a gilding effect.

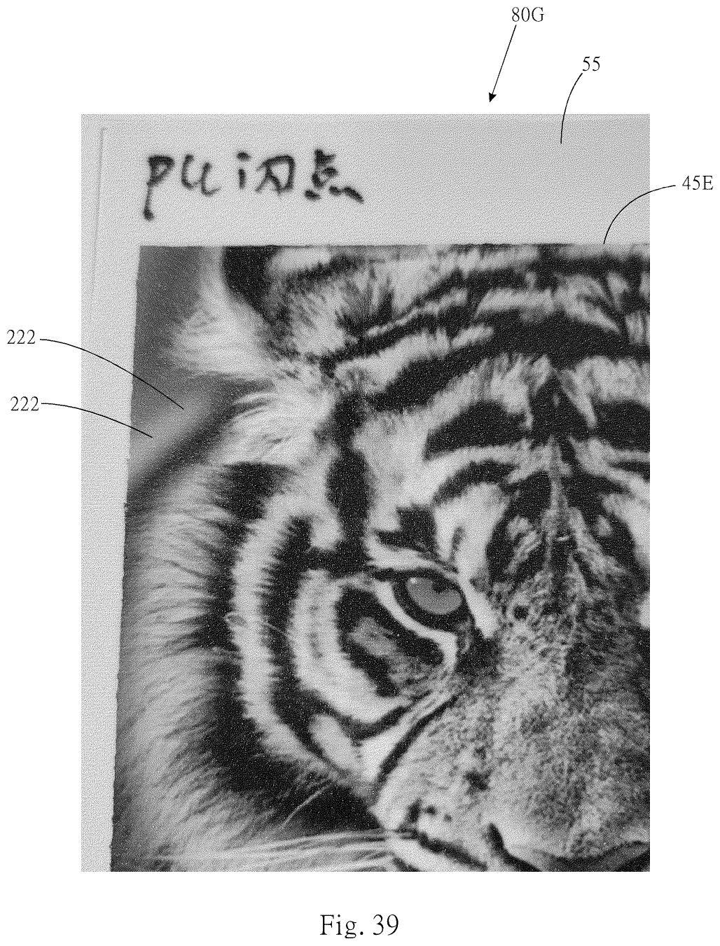

The surface film layer of a flexible sheet 80G in FIG. 39 has a fine dotted texture, so that the graphic 45E has a fine dotted texture 222.

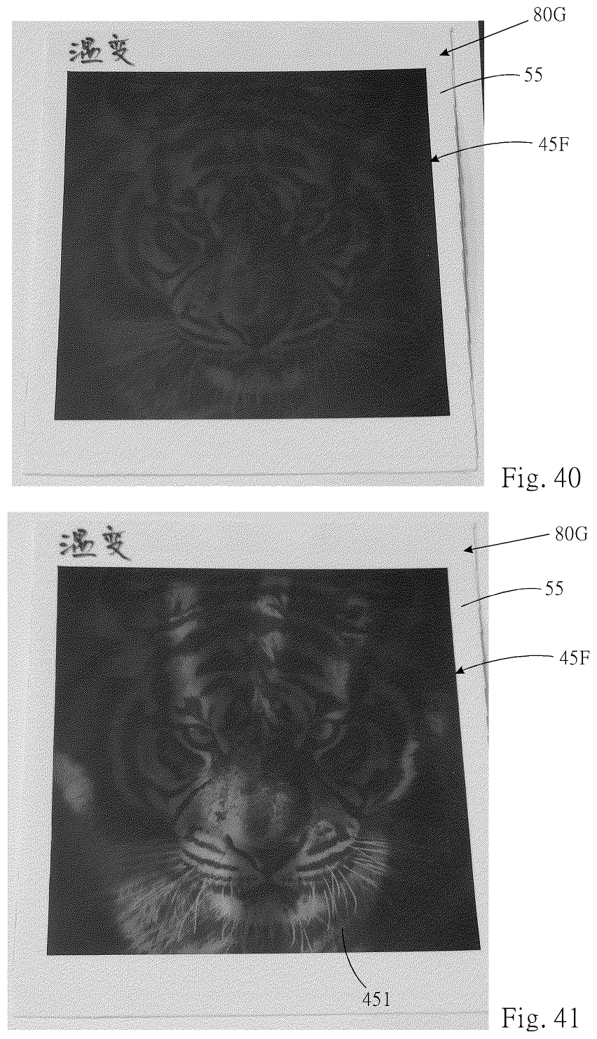

The surface film layer of the flexible sheet 80G shown in FIGS. 40 and 41 is added with a thermochromic pigment. The surface film layer forms a transparent or translucent thermochromic film that changes color due to changes in temperature. When a temperature does not change, the graphic 45F does not change color, as shown in FIG. 40. When the surface film layer is affected by temperature changes, the surface film layer will change color. FIG. 41 shows a palm touching the graphic 45F, and a discolored palm print 451 is produced on the graphic 45F due to temperature changes. The palm print 451 is formed by discoloration of the surface film layer. When there is no temperature difference, the palm print 451 will disappear.

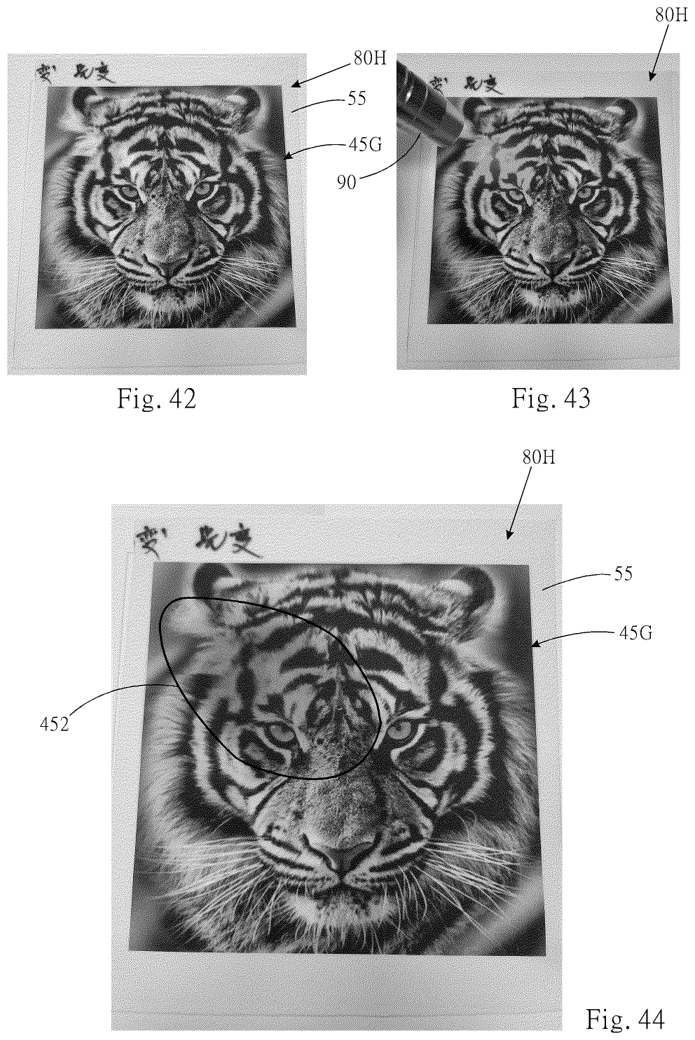

The surface film layer of a flexible sheet 80H shown in FIGS. 42 to 44 is added with a photochromic pigment, and the surface film layer forms a transparent or translucent photochromic film. When a light of a specific frequency is irradiated on the graphic 45G, for example, when a lamp 90 is used to irradiate ultraviolet light as shown in FIG. 43, an area 452 of the surface film layer where a light irradiates at will change color, causing the area 452 of the graphic 45G to change color, as shown in FIG. 44. When a light does not continuously irradiate, the discolored area 452 will disappear after a period of time, and a state of FIG. 42 will be restored.

Luminous powder can be added to the surface film layer of the flexible sheet of the invention, through a luminous light of the surface film layer, the graphic 45 becomes a luminous graphic.

The flexible sheet 80 provided by the invention can be cloth, leather, plastic film, paper, wood flake or metal flake, etc., so that a cloth such as clothing, pants, trousers or other types of flexible sheets can be formed with the graphic 45 provided with the pattern 32 thereon. Protected and isolated by the surface film layer 22, the graphic 45 will not be damaged, and the ink or toner of the pattern 32 of the graphic 45 will not diffuse, spread or fall off, capable of maintaining an integrity of the graphic 45 and the pattern 32 on the cloth, as well as maintaining a vividness of colors of the pattern 32. Tested by the inventor, the cloth was washed twenty times at a water temperature of 60° C. and dried after each washing, the graphic 45 (60) and the pattern 32 remained intact, colors remained bright and vivid, and there was no damage or color fading. The graphic 45 is resistant to sunlight and UV rays.

The surface film layer 22 of the graphic 45 becomes a functional layer, enabling the pattern 32 to have various texture effects as shown in the drawings, or 2D/3D visual effects or light-reflective functions. The surface film layer 22 can also be plated with the zinc sulfide layer 27 or the metal layer 28, so that the pattern 32 has an iridescent effect or a gilding effect. The metal layer 28 does not cover the entire surface film layer 22, the pattern 32 can still be displayed. The surface film layer 22 can also be added with pearlescent powder, glitter powder, luminous powder, photochromic pigment, or thermochromic pigment, so that the graphic 45 has an iridescent effect, a metallic effect, or a luminous effect, or a color can be changed due to changes in light or temperature. Alternatively, a fragrance/perfume can be added to the surface film layer 22. Each of the above-mentioned effects enhances an aesthetics of the pattern 32 and provides visual and olfactory sensations.

Consumers can use the techniques disclosed in the invention to make the graphic 45 on a cloth by DIY, and sportswear stores or general clothing stores can use the techniques disclosed in the invention to make the various graphics 45 and patterns 32 in a customized way at any position on apparel, such as clothing, shoes, hats, headscarves, headbands, wristbands, knee pads, towels, socks according to customer requirements.

Applying the invention to produce the flexible sheet with the graphic only requires production of a small number of specifications of the covering film 20, that is, for the surface film layer with or without embossing, the surface film layer with the light-reflective layer, the zinc sulfide layer, the metal layer, pearlescent powder, glitter powder, luminous powder, photochromic pigment, thermochromic pigment or fragrance/perfume, only fewer styles of the covering film 20 need to be manufactured. For manufacturers of the covering film, fewer styles of the covering film and less inventory can reduce manufacturing costs and inventory costs, and meet environmental protection requirements.

The invention is capable of maintaining an integrity of the graphic and the pattern on clothing, increasing a service life of clothing and reducing consumption of clothing. For manufacturers, the manufacturing method of the invention is capable of significantly reducing product styles and reducing manufacturing and development costs.

Although the invention has been disclosed as above with the embodiments, it is not intended to limit the invention. A person having ordinary skill in the art to which the invention pertains can make various changes and modifications without departing from the spirit and scope of the invention. Therefore, scope of protection of the invention shall be subject to what is defined in the pending claims.

What is claimed is

1. A flexible sheet with graphic, comprising:
a sheet material with flexibility;
a graphic being a multi-layered structure cut into a shape, and disposed on a surface of the sheet material, the graphic comprising:
a first adhesive layer;
a printing layer, a pattern being printed on the printing layer, one surface of the printing layer being bonded with the first adhesive layer, the pattern being located on another surface of the printing layer; and
a covering film comprising a transparent or translucent surface film layer and a second adhesive layer, the surface film layer being bonded with the another surface of the printing layer by the second adhesive layer and covering the printed pattern;
the graphic being adhered onto the sheet material by the first adhesive layer.

2. The flexible sheet as claimed in claim 1, wherein one surface of the surface film layer of the covering film is bonded with the second adhesive layer, and another surface of the surface film layer is a textured surface with a texture.

3. The flexible sheet as claimed in claim 2, wherein a texture of the surface film layer is a concave-convex texture or a texture forming a laser effect.

4. The flexible sheet as claimed in claim 1, wherein the covering film comprises a zinc sulfide layer bonded with one surface of the surface film layer.

5. The flexible sheet as claimed in claim 1, wherein the covering film comprises a metal layer bonded with one surface of the surface film layer, and the metal layer does not cover the entire surface film layer.

6. The flexible sheet as claimed in claimed 1, wherein the surface film layer of the covering film is added with pearlescent powder, glitter powder, luminous powder, photochromic pigment, thermochromic pigment, fragrance or anti-ultraviolet additives.

7. The flexible sheet as claimed in claim 1, wherein one surface of the surface film layer is provided with micro optical components, including: micro convex lenses, micro concave lenses, or micro convex or concave water droplet-shaped components.

8. The flexible sheet as claimed in claimed 1, wherein the surface film layer is a transparent or translucent light-reflective layer with a light-reflective component.

9. The flexible sheet as claimed in claimed 8, wherein the surface film layer is provided with zinc sulfide.

10. The flexible sheet as claimed in claimed 1, wherein the sheet material is cloth, leather, plastic film, paper, wood flake or metal flake.

11. The flexible sheet as claimed in claimed 1, wherein the first adhesive layer and the second adhesive layer are hot melt adhesive layers, capable of producing viscosity when being heated.
